(19) United States
(12) Patent Application Publication
(10) Pub. No.: US 2025/0335477 A1
(43) Pub. Date: Oct. 30, 2025

(54) USING CONVERSATION TOPICS FOR ONLINE CONVERSATIONS BASED ON MACHINE LEARNING BASED LANGUAGE MODELS

(71) Applicant: Wisq Inc., Atherton, CA (US)

(72) Inventors: Chih-Po Wen, San Mateo, CA (US); Min Zhang, Sunnyvale, CA (US); Angela K. Shoemaker, Lincoln, NE (US); Akshay More, Sunnyvale, CA (US); Clayton Holz, Sacramento, CA (US); James J. Barnett, Atherton, CA (US); Duphong Nguyen, Santa Clara, CA (US)

(21) Appl. No.: 19/192,120

(22) Filed: Apr. 28, 2025

Related U.S. Application Data
(60) Provisional application No. 63/640,131, filed on Apr. 29, 2024.

(51) Int. Cl. G06F 16/3329; G06F 16/383; G06F 40/35; G06Q 10/107

(52) U.S. Cl. CPC G06F 16/3329; G06F 16/383; G06F 40/35; G06Q 10/107

(57) ABSTRACT

A system manages conversation topics and uses them in an online conversation. The system generates metadata describing a set of conversation topics based on the conversation. The metadata describes a particular conversation topic comprises a summary of interactions relevant to the particular conversation topic. The system receives a natural language request from the user via the user interface. The system generates one or more prompts comprising the natural language request and metadata describing the set of conversation topics and request the machine learning based language model to generate a reply to the natural language request using a conversation topic relevant to the natural language request. The system provides the prompts to the machine learning based language model for execution and receives responses from the machine learning based language model. The system generates a reply based on the one or more responses.

### CROSS REFERENCE TO RELATED APPLICATION

This application claims the benefit under 35 U.S.C. § 119(e) of U.S. Provisional Patent Application Ser. No. 63/640,131, filed on Apr. 29, 2024, which is herein incorporated by reference in its entirety.

### TECHNICAL FIELD

The present disclosure relates to machine learning based language models in general and more specifically to managing online conversations using machine learning based language models and retrieval-augmented generation.

### BACKGROUND

Artificial intelligence techniques such as machine learning based language models are used for natural language processing. For example, chatbots are used for automatically responding to natural language requests from users. Natural language requests are often processed using large language models (LLMs.) LLMs typically have a transformer-based neural network architecture and are trained on large amount of data from various data sources, for example, websites, articles, posts on the web, and the like. Since LLMs are trained on generic training data, they provide generic answers that are applicable to a wide context. Such answers are typically not helpful when the questions need to be answered within a specific context. Furthermore, LLMs also suffer from the problem of hallucination, thereby providing misleading and incorrect information. For certain domains generic answers as well as hallucinations are not acceptable. For example, providing accurate answers is critical for such domains. As a result, state of the art LLMs are often inadequate for such tasks.

### SUMMARY

A system, for example, an online system performs online conversations with users associated with an organization. The system configures a user interface for performing conversations and receives natural language requests from the user and uses a machine learning based language model to generate replies to the natural language requests. The system performs a conversation comprising interactions with a user via a user interface. Each interaction comprises a natural language request received from the user and a reply to the natural language request generated using a machine learning based language model. The system provides the replies generated in response to the natural language requests to the user, for example, by displaying them via the user interface.

A system performs routing of conversation flow routing for an online conversation. The online system stores metadata describing a plurality of conversation flow types. Each conversation flow type comprises a sequence of steps, each step describing a natural language-based interaction with a user. The system performs the following steps repeatedly. The system receiving a natural language request from the user via the user interface. The system generates a prompt for input to a machine learning based language model. The prompt comprises the natural language request and metadata describing one or more conversation flow types and requests the machine learning based language model to identify a particular conversation flow type relevant to the natural language request. The system provides the prompt to the machine learning based language model for execution and receives a response generated by the machine learning based language model based on the prompt. The response identifies a conversation flow type relevant to the natural language request. For one or more subsequent natural language requests received via the user interface from the user, the system follows the steps of the identified conversation flow type and generates a reply based on steps of the identified conversation flow type. The system sends the generated reply for display via the user interface.

According to an embodiment the system manages data sources used in an online conversation performed using machine learning based language models. The system stores data obtained from a plurality of data sources in a vector database. Each data source stores information associated with users of an organization. For example, a data source may store information describing user profiles of users of the organization, event information associated with users of the organization, documents storing policies of the organization, conversation data of conversation channels used by the organization such as emails, messages, and so on. The system receives a natural language request from a user via a user interface. The system generates a prompt for input to a machine learning based language model. The prompt includes the natural language request and metadata describing each of the plurality of data sources and requests a machine learning based language model to generate queries for extracting data relevant to the natural language request from the plurality of data sources. The system provides the prompt to the machine learning based language model for execution and receives a response generated by the machine learning based language model. The response comprises queries for extracting data relevant to the natural language request from the plurality of data sources. The system executes the queries against the vector database to extract information relevant to the natural language request from the plurality of data sources and uses the information extracted from the vector database for generating a reply to the natural language request using the machine learning based language model. The system sends the reply to the user via the user interface.

According to an embodiment, the system generates a second prompt for input to the machine learning based language model. The second prompt comprises the natural language request and information extracted from the plurality of data sources and requests the machine learning based language model to generate a reply to the natural language request. The system receives a second response obtained by executing the machine learning based language model using the second prompt and generates a reply to the natural language request based on the second response generated by the machine learning based language model based on the second prompt.

According to an embodiment the system manages conversation topics and uses them in an online conversation. The system generates metadata describing a set of conversation topics based on the conversation. The metadata describes a particular conversation topic comprises a summary of interactions relevant to the particular conversation topic. The system repeatedly performs the following steps. The system receives a natural language request from the user via the user interface. The system generates one or more prompts for providing to a machine learning based language model. The one or more prompts comprise the natural language request and metadata describing the set of conversation topics and request the machine learning based language model to generate a reply to the natural language request using a conversation topic relevant to the natural language request. The system provides the one or more prompts to the machine learning based language model for execution and receives one or more responses generated by the machine learning based language model based on the one or more prompts. The system sends a reply based on the one or more responses for display via the user interface.

According to an embodiment, the system generates a first prompt comprising the natural language request and metadata describing the set of conversation topics and requesting the machine learning based language model to identify a particular conversation topic relevant to the natural language request. The system generates a second prompt comprising the natural language request and the particular conversation topic, the second prompt requesting the machine learning based language model to generate a reply to the natural language request in relation to the particular conversation topic.

According to an embodiment, the system provides the first prompt to the machine learning based language model for execution and receives a response generated by the machine learning based language model based on the first prompt. The response identifies the particular conversation topic relevant to the natural language request. The system provides the second prompt to the machine learning based language model for execution.

According to an embodiment, the system uses critical analysis for performing conversations associated with an organization. The system generates a prompt for input to a machine learning based language model. The prompt comprises the natural language request and interactions of the conversation and requesting a machine learning based language model to evaluate the conversation to perform a critical analysis of the conversation. The critical analysis determines one or more attributes of the conversation. The system provides the prompt to the machine learning based language model for execution and receives a response generated by the machine learning based language model based on the prompt. The response includes values for the one or more attributes of the conversation. The system modifies prompts generated for responding to one or more subsequent natural language requests received from the user to cause the machine learning based language model to generate responses that cause the one or more attributes to change.

### BRIEF DESCRIPTION OF THE DRAWINGS

FIG. 1 illustrates an example system environment for an online system that performs conversations with users of an organization, in accordance with one or more embodiments.

FIG. 2 illustrates an example system architecture for an online system 140, in accordance with some embodiments.

FIG. 3 is a flowchart for performing an online conversation with a user of an organization, in accordance with one or more embodiments.

FIG. 4 illustrates conversation flow routing performed by the conversation engine, in accordance with one or more embodiments.

FIG. 5 is a flowchart for processing natural language requests received from a user by performing conversation flow routing, in accordance with one or more embodiments.

FIG. 6A is a flowchart for performing an online conversation with a user of an organization, in accordance with one or more embodiments.

FIG. 6B is a flowchart that described a data pipeline implemented by the steps 600 of the flowchart of FIG. 6A, in accordance with one or more embodiments.

FIG. 7 is a flowchart for performing an online conversation with a user of an organization, in accordance with one or more embodiments.

FIG. 8 is a flowchart for performing an online conversation with a user of an organization, in accordance with one or more embodiments.

The figures depict various embodiments of the present invention for purposes of illustration only. One skilled in the art will readily recognize from the following discussion that alternative embodiments of the structures and methods illustrated herein may be employed without departing from the principles described herein.

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (computer-readable medium or method) for purposes of illustration only. One skilled in the art will readily recognize from the following description that alternative embodiments of the structures and methods illustrated herein may be employed without departing from the principles described herein.

### DETAILED DESCRIPTION

An online system performs conversations with users of an organization in relation to the organization. An organization typically includes a group of people that work in association with each other. Typically, people of an organization form a hierarchy such that subsets of people from the organization may report to one or more people of the organization. This structure may be repeated recursively forming a hierarchy. People of the organization may store information associated with the members of the organization, for example, user profiles, events, communications performed by users, and so on. An organization may be a company and the users may be employees of the company.

The online system presents a chat interface that allows users to ask questions related to the organization or to other users of the organization. The online system generates prompts and sends to a machine learning based language model to get a response. The online system maintains various data sources are maintained and updated, for example, profile, events, chat history, and so on. The data of the data sources is stored in a vector database. The online system extracts relevant information from the data sources and provides them to the machine learning based language model in a prompt for generating a response to a natural language request received from a user.

The online system supports multiple conversation flow types and routes the conversation to an appropriate conversation flow type. The online system maintains conversation topics being discussed in a conversation and tracks progress for each topic. The system allows users to switch topics during a conversation. The online system monitors the conversations to generate critical analysis of the conversation, for example, by analyzing the pacing of the conversation, the types of personalities of the participants of the conversation and uses the critical analysis to modify subsequent responses generated during the conversation.

According to an embodiment, the chat interface allows users of the organization to ask questions that guide them for various issues or various topics related to the organization. Accordingly, the online system acts as a coach that guides or advises users of the organization on various topics related to the organization, for example, questions related to interactions between users, questions related to handling of specific user situations based on policies of the organization.

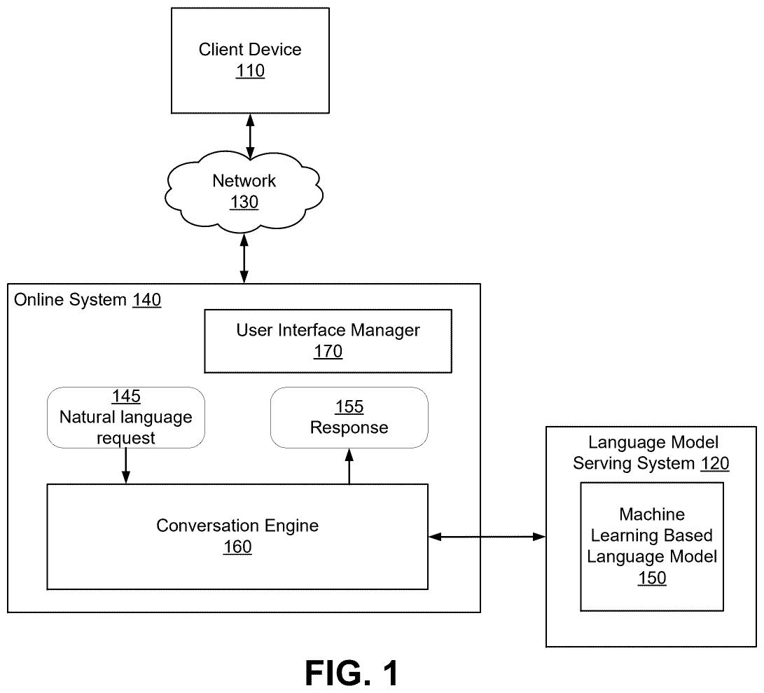

FIG. 1 illustrates an example system environment for an online system that performs conversations with users of an organization, in accordance with one or more embodiments. The system environment illustrated in FIG. 1 includes client devices 110, an online system 140, a network 130, and a language model serving system 120. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

The online system 140 includes a conversation engine 160 and a user interface manager 170. The user interface manager 170 configures user interfaces and presents them to the user via the client device 110. According to an embodiment, the user interface is a chat interface configured to perform a natural language conversation with a user. The online system 140 receives natural language requests 145 from users via the user interface and generated replies to the natural language requests and send for display to the user via the user interface. The conversation engine 160 generates a reply using a machine learning based language model 150. The machine learning based language model 150 may be stored within the online system 140 or may be hosted as a service by an external system, for example, the language model serving system 120 that allows users to invoke the machine learning based language model 150 using APIs (application programming interfaces) of the language model serving system 120.

The client device 110 provides a user interface to a user to allow the user to perform conversation using natural language inputs. The client device 110 can be a personal or mobile computing device, such as a smartphone, a tablet, a laptop computer, or desktop computer. In some embodiments, the client device 110 executes a client application that uses an application programming interface (API) to communicate with the online system 140.

The client device 110, the online system 140, and the language model serving system 120 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The language model serving system 120 receives requests from the online system 140 to perform tasks using the machine learning based language model 150. The tasks include, but are not limited to, natural language processing (NLP) tasks, audio processing tasks, image processing tasks, video processing tasks, and the like. In one embodiment, the machine-learned models deployed by the language model serving system 120 are models configured to perform one or more NLP tasks. The NLP tasks include, but are not limited to, text generation, query processing, machine translation, chatbots, and the like. In one embodiment, the language model is configured as a transformer neural network architecture. Specifically, the transformer model is coupled to receive sequential data tokenized into a sequence of input tokens and generates a sequence of output tokens depending on the task to be performed.

The language model serving system 120 receives a request including input data (e.g., text data, audio data, image data, or video data) and encodes the input data into a set of input tokens. The language model serving system 120 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a text generation task, the transformer model may receive a prompt and continue the conversation or expand on the given prompt in natural language text.

In one embodiment, the machine learning based language model 150 is a large language models (LLM) that is trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one embodiment, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one embodiment, the task for the language model serving system 120 is based on knowledge of the online system 140 that is fed to the machine-learned model of the language model serving system 120, rather than relying on general knowledge encoded in the model weights of the model. According to an embodiment, the language model interface module 270 includes an index that comprises data structures that store information obtained from external sources, for example, a corpus of unstructured text representing user comments. Examples of such an index include GPT Index and LlamaIndex. The index allows the system to connect the corpus of information with a machine learning based language model so that the answers to a prompt are based on the knowledge of the trained machine learning based language model as well as the information stored in the corpus. Accordingly, in the system as disclosed the answers to prompts requesting insights are based on knowledge of the trained machine learning based language model as well as the information stored in the corpus or user comments.

The online system 140 provides natural language request received from a user to the language model interface module 270. The online system 140 receives a response to the prompt from the language model interface module 270 based on execution of the machine-learned model in the language model serving system 120 using prompts generated by the language model interface module 270. The online system 140 obtains the response and provides the requested information to the user.

The language model interface module 270 obtains one or more responses from the language model serving system 120 and synthesizes a response to the query on the external data. While the online system 140 can generate a prompt for a machine learned language model using the external data as context, the amount of information in the external data may exceed prompt size limitations of the machine learning based language model. The language model interface module 270 resolves prompt size limitations by generating a structured index of the data.

The language model interface module 270 receives one or more queries from the online system 140 on the external data. The language model interface module 270 constructs one or more prompts for input to the language model serving system 120. A prompt may include the query of the user and context obtained from the structured index of the external data. In one instance, the context in the prompt includes portions of information obtained from the index as contextual information for the query.

The example system environment in FIG. 1 illustrates an environment where the machine learning based language model 150 is managed by a separate system from the online system 140, i.e., the language model serving system 120. Accordingly, the online system 140 sends requests to the language model serving system 120 to invoke APIs of the language model serving system 120, for example, to execute the machine learning based language model 150. In other embodiments, the machine learning based language model 150 may be managed by the online system 140. For example, the online system 140 may train the machine learning based language model 150 and directly invoke the machine learning based language model 150 instead of sending requests to an external system.

### System Architecture

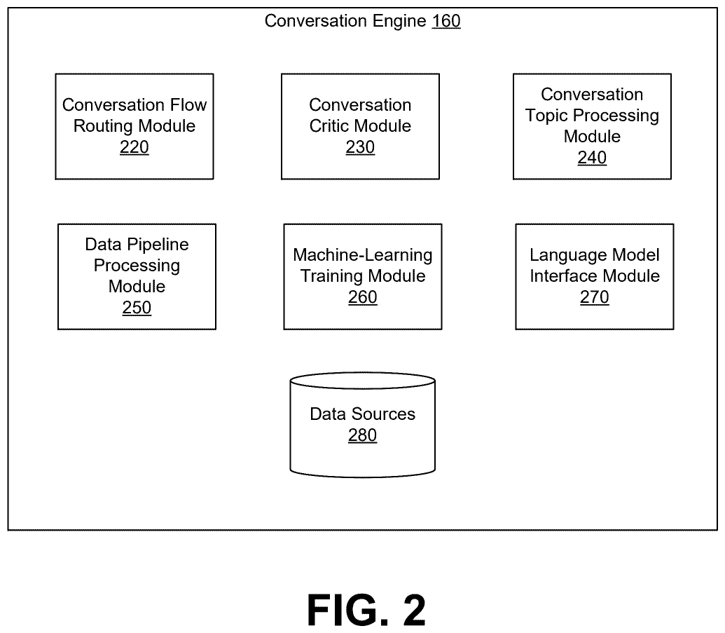

FIG. 2 illustrates an example system architecture for an online system 140, in accordance with some embodiments. The system architecture illustrated in FIG. 2 includes a conversation flow routing module 220, a conversation critic module 230, a conversation topic processing module 240, a data pipeline processing module 250, a machine learning training module 260, a language model interface module 270, and data sources 280. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The conversation flow routing module 220 routes an incoming natural language request 145 from a user to an appropriate conversation flow type so that subsequent user interactions conform to the conversation flow type. The conversation critic module 230 performs critical analysis of an ongoing conversation with a user so that the conversation can be dynamically modified as the conversation is taking place. The conversation topic processing module 240 identifies one or more conversation topics that are being discussed with a user and tracks progress and actions associated with each conversation topic. The data sources 280 store data associated with the organization and specific users of the organization. The data sources 280 may be stored in a vector database. The data pipeline processing module 250 uses the machine learning based language model 150 to generate queries for extracted data relevant to a natural language request from the user for providing with a prompt to the machine learning based language model 150. The language model interface module 270 interfaces with a machine learning based language model 150 that may be stored locally within the online system 140 or in an external system such as language model serving system 120.

The machine learning training module 260 trains machine learning models used by the online system 140. For example, the machine learning training module 260 may train the item selection model, the availability model, or any of the machine-learned models deployed by the language model serving system 120. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 260 generates the set of parameters for a machine learning model by “training” the machine learning model. Once trained, the machine learning model uses the set of parameters to transform inputs into outputs.

The machine learning training module 260 trains a machine learning model based on a set of training examples. Each training example includes input data to which the machine learning model is applied to generate an output. In some cases, the training examples also include a label which represents an expected output of the machine learning model. In these cases, the machine learning model is trained by comparing its output from input data of a training example to the label for the training example.

The machine learning training module 260 may apply an iterative process to train a machine learning model whereby the machine learning training module 230 trains the machine learning model on each of the set of training examples. To train a machine learning model based on a training example, the machine learning training module 260 applies the machine learning model to the input data in the training example to generate an output. The machine learning training module 260 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 260 updates the set of parameters for the machine learning model based on the score generated by the loss function. For example, the machine learning training module 260 may apply gradient descent to update the set of parameters.

### Overall Process

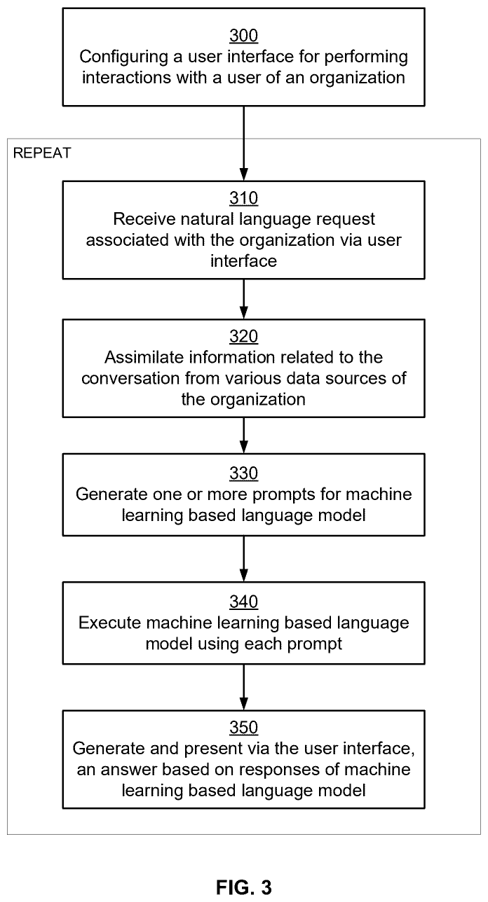

FIG. 3 is a flowchart for performing an online conversation with a user of an organization, in accordance with one or more embodiments. Alternative embodiments may include more, fewer, or different steps from those illustrated in FIG. 3, and the steps may be performed in a different order from that illustrated in FIG. 3. These steps may be performed by a system (e.g., online system 140). Additionally, each of these steps may be performed automatically by the online system without human intervention.

The online system 140 configures 300 a user interface, for example, a chat-interface for allowing users to perform, natural language conversations with the online system 140. The online system 140 sends the user interface for display via the client device 110.

The conversation engine 160 performs the conversation by repeating the steps 310, 320, 330, 340, and 350. The conversation engine 160 receives 310 a natural language request 145 from the user via the user interface. The conversation engine 160 assimilates 320 information related to the ongoing conversation (of which the natural language request is a part of) from various data sources of the organization.

The conversation engine 160 generates 330 one or more prompts for the machine learning based language model 150 based on the natural language request 145. Each prompt includes additional information relevant to the natural language request 145. The conversation engine 160 sends the prompt for execution to the language model serving system 120. The language model serving system 120 executes the machine learning based language model 150 using the received prompt to generate a response. The language model serving system 120 sends the generated response to the conversation engine 160. The conversation engine 160 generates an answer (or a reply) to the natural language request from the user and sends the answer for display via the user interface. These steps 310, 320, 330, 340, and 350 may be repeated multiple times to perform one or more conversations with the user.

Even though the embodiments described herein may use multiple prompts for generating a reply to a natural language question using a conversation topic, the system may generate the reply using a single prompt. Accordingly, the system generates a response based on one or more prompts provided to the machine learning based language model that result in one or more responses. The system may use the information I1 received in one response R1 for providing to the next prompt that generates response R2. Alternatively, the system may request the machine learning based model using a single prompt to determine information I1 and use it for generating the response R2.

### Conversation Flow Routing

The conversation engine 160 performs natural language based conversations with users, for example, with users of an organization to answers questions associated with the organization. The conversation engine 160 analyzes the natural language request received from the user to identify a type of conversation flow to follow for the received natural language request. Each conversation flow type is associated with a sequence of steps. Accordingly, the conversation engine 160 performs conversation flow routing for each natural language request received. The conversation engine 160 generates subsequent responses to the user based on the steps of the identified conversation flow. Accordingly, the conversation engine 160 generates responses to follow the steps of the sequence of steps of the identified conversation flow type.

Examples of conversation flows include an onboarding conversation flow that is used when a person starts a conversation for the first time with the online system 140. A conversation flow may be domain specific. For example, if the online conversation is for advising users of an organization regarding issues encountered in an organization, a conversation flow type may represent steps to guide a user on how to effectively delegate a task. Another example, conversation flow type may guide a user to conduct difficult conversations with members of the organization. Aa another example, conversation flow type may ask the user to read some content and then engage the user in a conversation related to the reading, for example, questions asking the user to apply the reading to a situation faced by the user.

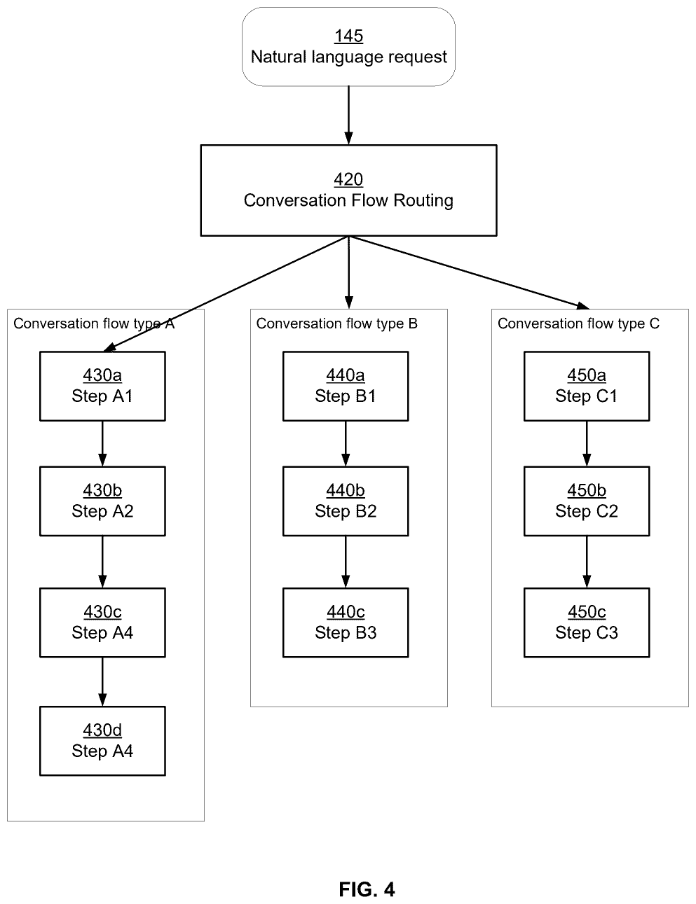

FIG. 4 illustrates conversation flow routing performed by the conversation engine, in accordance with one or more embodiments. The conversation engine 160 stores metadata describing various conversation flow types. The metadata describes the various steps of each conversation flow type. As illustrated in FIG. 4, the conversation engine 160 receives a natural language request 145 from a user. The conversation engine 160 analyzes the request to perform conversation flow routing 420, i.e., to determine the type of conversation flow that should be followed based on the natural language request 145. According to an embodiment, the conversation engine 160 may use the machine learning based language model to perform the conversation flow routing 420. As illustrated in FIG. 4, the conversation engine 160 may identify one of the conversation flow types from types A, B, and C. The conversation engine 160 subsequently generates responses to perform the steps of the corresponding conversation flow type. For example, if the conversation engine 160 selects the conversation flow type A, the conversation engine 160 subsequently performs the steps A1, A2, A3, and A4; if the conversation engine 160 selects the conversation flow type B, the conversation engine 160 subsequently performs the steps B1, B2, and A3; and if the conversation engine 160 selects the conversation flow type C, the conversation engine 160 subsequently performs the steps C1, C2, and C3.

Each step 430, 440, 450 of the conversation flow comprises smaller steps, for example, a step may comprise (1) a step S1 that analyzes conversation status to determine which step to execute next, and (2) a step S2 that executes reply for the current step.

To perform a particular step of a conversation flow type, the conversation engine 160 generates an appropriate prompt for the machine learning based language model 150. For example, the prompt may identify the current step that is being executed and the conversation flow type that was identified and request the machine learning based language model 150 to generate a response 155 accordingly for responding to the natural language request 145 received from the user.

The next few responses generated for the user are based on the conversation flow identified. For example, if the conversation flow type is type A and the current step if step A1, the conversation engine 160 generates a response accordingly and presents to the user. The conversation engine 160 may receive the next natural language request 145 from the user via the user interface. Since step A1 is executed, the conversation engine 160 updates the current step to step A2 of conversation flow type A. The conversation engine 160 generates a prompt for the language model serving system 120 that indicates that the current conversation flow type is A and the current step is A2 and the language model serving system 120 should generate a response to the natural language request 145 received accordingly. The conversation engine 160 receives the response and presents to the user via the user interface. This process continues until all the steps of the sequence of steps of conversation flow type A are completed. For example, the conversation engine 160 receives the next natural language request 145. Since step A2 is now executed, the conversation engine 160 updates the current step to step A3 of conversation flow type A. The conversation engine 160 generates a prompt for the language model serving system 120 that indicates that the current conversation flow type is A and the current step is A3 and the language model serving system 120 should generate a response to the natural language request 145 received accordingly. The conversation engine 160 receives the response and presents to the user via the user interface.

When all the steps of the current conversation flow type are completed, for example, when the step A4 of conversation flow type A in the above example is executed, the conversation engine 160 receives the next natural language request 145 and perform the conversation flow routing 420 again to identify the next conversation flow type and executes the steps of the next conversation flow identified.

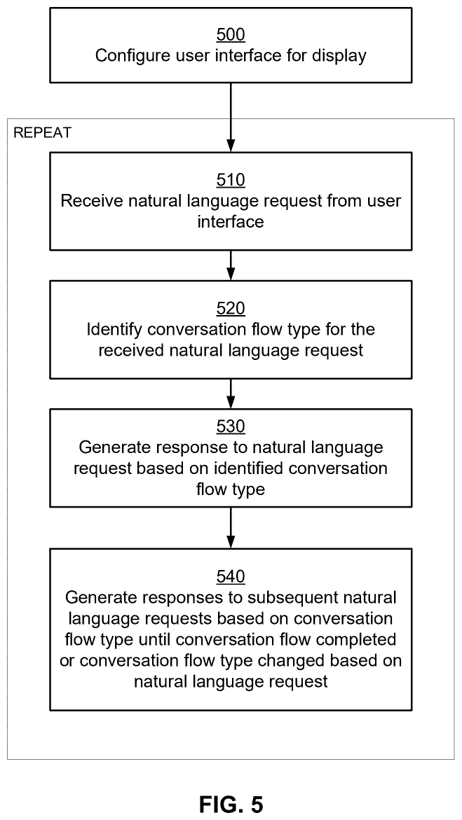

FIG. 5 is a flowchart for processing natural language requests received from a user by performing conversation flow routing, in accordance with one or more embodiments. Alternative embodiments may include more, fewer, or different steps from those illustrated in FIG. 5, and the steps may be performed in a different order from that illustrated in FIG. 5. These steps may be performed by a system (e.g., online system 140). The steps may be executed by various modules of the online system 140 for example, the conversation flow routing module 220 of the conversation engine 160. Additionally, each of these steps may be performed automatically by the online system without human intervention. The process described herein can be used for various applications.

The conversation engine 160 configures 500 a user interface, for example, the chat interface and send it for display via the client device 110. The conversation engine 160 repeats the steps 510, 520, 530, 540 to perform a natural language conversation with a user. The conversation engine 160 receives 510 a natural language request via the user interface. The conversation engine 160 identifies a conversation flow type based on the natural language request received. The conversation engine 160 may use the language model serving system 120 to identify the conversation flow. For example, the conversation engine 160 may generate a prompt including information describing various conversation flow types and the received natural language request and requesting the machine learning based language model 150 to identify the conversation flow type relevant to the natural language request received. The conversation engine 160 identifies 520 the conversation flow type relevant to the natural language request based on the response received from the machine learning based language model 150. The conversation engine 160 retrieves metadata describing the identified conversation flow type, for example, the various steps of the conversation flow type. The conversation engine 160 generates 530 a response to the natural language request based on the conversation flow type, for example, according to the first step of the conversation flow type. The conversation engine 160 processes the next few natural language requests received from the user according to the sequence of steps of the identified conversation flow type. Accordingly, the conversation engine 160 generates 540 the responses to subsequent natural language requests received from the users in accordance with each step of the identified conversation flow type. The step 540 may be continued until the conversation flow is completed or the conversation flow type is changed as a result of the user request, for example, if the user decides to change the topic of conversation.

The conversation engine 160 tracks the current step of the conversation flow type being processed at any stage. The conversation engine 160 generates a prompt for the machine learning based language model 150 that includes the latest natural language request received from the user, the identified conversation flow type, and the current step of the conversation flow type being executed. The machine learning based language model 150 generates a response based on the prompt and provides to the conversation engine 160. The conversation engine 160 generates a reply to the user based on the response received from the machine learning based language model 150. The conversation engine 160 increments the current step to the next step of the conversation flow type until the last step of the conversation flow type is reached or the conversation flow type is changed as a result of the current natural language request (for example, if the user started talking about a different topic). Once all the steps of the conversation flow type are executed, the conversation engine 160 starts processing from the step 510 again to receive the next natural language request and perform the conversation flow routing by identifying 520 the next conversation flow type and processing the natural language request and subsequent natural language requests in accordance with the next conversation flow type identified.

### Data Pipeline/Data Sources Management

The conversation engine 160 uses several data sources for storing and managing information relevant to an organization and to users of the organization for answering natural language questions associated with the organization. The conversation engine 160 extracts data from various data sources of an organization and stores the extracted data in a vector database.

Examples of data sources include: (1) user profiles storing information describing each user of the organization with information that is accumulated over time and is evolving; (2) events associated with the user and the organization indicating how the user is performing within an organization; events may be generated based on user interactions performed by the user with various online systems within the organization, information collected from communication channels (chat, teams, messaging platform, emails etc. that the user authorizes the conversation engine 160 to use); (3) the organization's learning management system; (4) the organizations polices including employee handbook, documents related to company's policies, procedures and so on; (5) guardrails representing the organization's code of conduct and rules for handling violations and including policies describing which entity within the organization should handle matters related to specific violations.

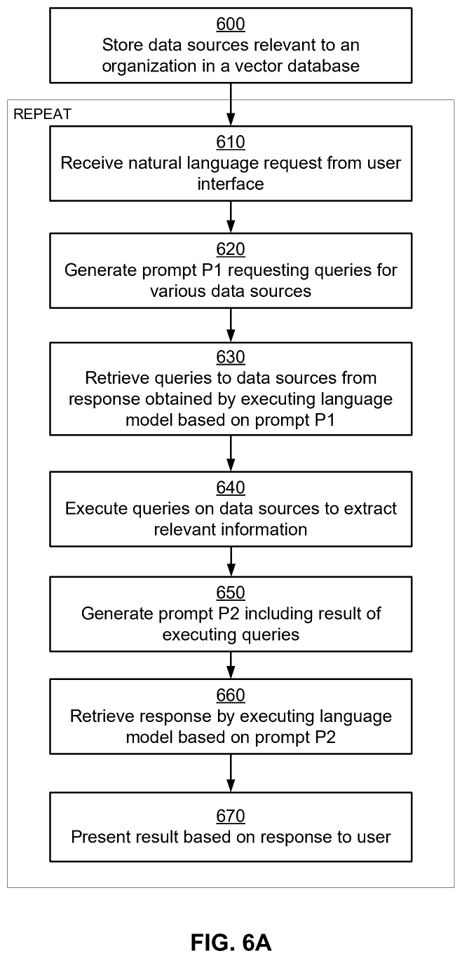

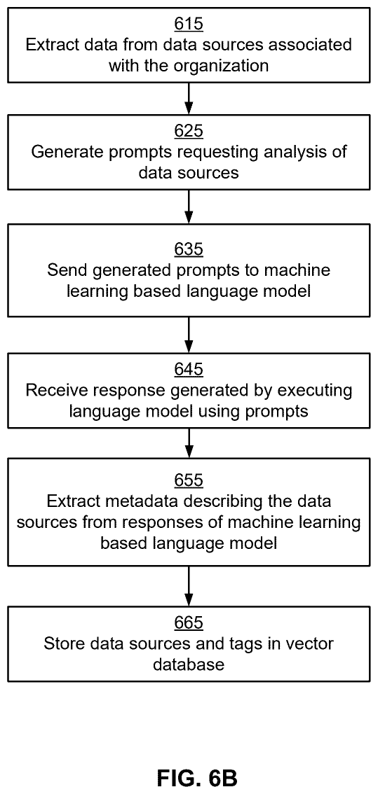

FIG. 6A is a flowchart for performing an online conversation with a user of an organization, in accordance with one or more embodiments. Alternative embodiments may include more, fewer, or different steps from those illustrated in FIG. 3, and the steps may be performed in a different order from that illustrated in FIG. 3. These steps may be performed by a system (e.g., online system 140). Additionally, each of these steps may be performed automatically by the online system without human intervention. The steps may be executed by the conversation engine 160, for example by the data pipeline processing module 250.

The conversation engine 160 stores 600 data of the various data sources in a vector database. The step 600 implements a data pipeline as illustrated in FIG. 6B. The conversation engine 160 performs conversations with users of the organization by repeating the steps 610, 620, 630, 640, 650, 660, 670. The conversation engine 160 receives 610 a natural language request from a user. The natural language request is associated with the organization. The conversation engine 160 generates an answer to the natural language request based on information stored in the data sources.

The conversation engine 160 generates 620 a prompt P1 requesting queries for the data sources for extracting information relevant to answering the natural language request. The prompt may include the natural language request and description of each data source including: (1) Description and hint when to use this data source (2) Type of files in this data source (3) Expiration date (to get recent data) (4) a question template for queries for this data source; (5) an answer template describing how to answer a question based on the data source; (6) a no-answer template describing how to answer the question based on the data source if there is no answer available in the data source so that the machine learning based language model 150 does not manufacture answers based on knowledge learnt from other organizations that is unlikely to be relevant to this particular organization; (6) Precedence rules specifying how to handle conflicts if there are multiple data sources that have an answer available for certain question.

The conversation engine 160 sends the prompt P1 to the language model serving system 120 for executing the machine learning based language model 150 using the prompt P1. The conversation engine 160 receives the response from the machine learning based language model 150 and retrieves 630 queries to various data sources from the response received from the machine learning based language model 150.

The conversation engine 160 executes 640 the queries against the vector database storing the data sources to extract information relevant to the natural language request of the user. The conversation engine 160 generates 650 another prompt P2 including the results of executing the queries and the natural language request and requesting the machine learning based language model 150 to generate a response to the natural language request based on the information provided. The conversation engine 160 sends the prompt P2 to the language model serving system 120 for executing the machine learning based language model 150 using the prompt P2. The conversation engine 160 retrieves 660 the response obtained by executing the machine learning based language model 150 using the prompt P2. The conversation engine 160 presents the response to the natural language request of the user based on the response generated by executing the machine learning based language model 150 using the prompt P2.

The conversation engine 160 repeats the above steps to answer various natural language requests received from the user.

FIG. 6B is a flowchart that described a data pipeline implemented by the steps 600 of the flowchart of FIG. 6A, in accordance with one or more embodiments. The conversation engine 160 extracts 615 data from various data sources, including external data sources and data sources of the organization. The data sources may be document repositories of the organization that store documents such as organizations employee handbook or human resources (HR) policies. The data sources may store conversation data of conversation channels used by the organization, for example, messaging channels, emails, teams, and so on, assuming the user has authorized the online system 140 to access the data from these communication channels.

The conversation engine 160 generates prompts 625 for the machine learning based language model 150. A prompt may include samples of data stored in a data source and requests the machine learning based language model 150 to generate tags that describe the data source. The conversation engine 160 sends 635 the prompts to the machine learning based language model 150 to generate tags describing various data sources. The conversation engine 160 receives 645 the response from the machine learning based language model 150 and extracts 655 metadata from the response to store as tags describing various data sources. The 160 stores 665 documents comprising the data sources and their corresponding tags in the vector database. The tags improve the precision of the searched performed using the data sources.

### Conversation Topic Management

According to an embodiment, the conversation engine 160 maintains one or more conversation topics that the user is discussing with the conversation engine 160. The conversation engine 160 tracks each conversation topic and makes sure that progress is being made for each conversation topic. The conversation engine 160 may display the conversation topics in the user interface used by the user for providing the natural language requests. A conversation topic may also be referred to herein as a conversation theme or a topic. According to an embodiment, a conversation topic is stored as one or more phrases or keywords.

The conversation engine 160 maintains metadata describing each conversation topic, for example, (1) a summary of all relevant conversations performed with the user by the conversation engine 160 that concern this conversation topic; (2) possible outcomes related to this conversation topic; (3) various options related to this conversation topic; (4) any actions related to this topic that were performed; (5) any follow up actions that need to be performed and their corresponding timestamps indicating when the actions should be performed.

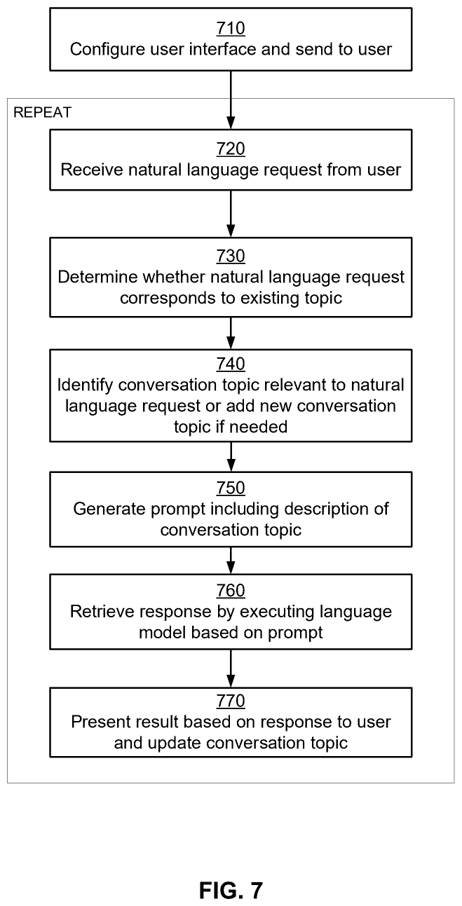

FIG. 7 is a flowchart for performing an online conversation with a user of an organization, in accordance with one or more embodiments. Alternative embodiments may include more, fewer, or different steps from those illustrated in FIG. 3, and the steps may be performed in a different order from that illustrated in FIG. 3. These steps may be performed by a system (e.g., online system 140). Additionally, each of these steps may be performed automatically by the online system without human intervention. The steps of the process illustrated in FIG. 7 may be performed by the modules of the online system 140 for example, the conversation topic processing module 240.

The conversation engine 160 configures 710 a user interface and sends to the user. The user interface may include description of one or more conversation topics based on conversations with the user performed by the conversation engine 160. The conversation engine 160 repeats the steps 720, 730, 740, 750, 760, 770 for performing conversation with the user. The conversation engine 160 receives 720 a natural language request from the user.

The conversation engine 160 determines 730 whether the natural language request received from the user matches any of the available conversation topics. According to an embodiment, the conversation engine 160 sends a prompt P1 to the machine learning based language model 150 including the natural language request and description of available conversation topics and requests the machine learning based language model 150 to determine whether the natural language request corresponds to any available conversation topics and to identify the matching conversation topic. The conversation engine 160 identifies 740 a conversation topic relevant to the natural language request based on the response received from the machine learning based language model 150. If the response provided by the machine learning based language model 150 indicates that none of the conversation topics match the natural language request, the conversation engine 160 generates a new conversation topic. The conversation engine 160 may generate a new conversation topic by either sending a new prompt to the machine learning based language model 150 with a request to generate a new conversation topic for the natural language request. Alternatively, the new conversation topic may be generated by the machine learning based language model 150 in response to the previous prompt P1 that requests the machine learning based language model 150 to identify a matching conversation topic if available or to generate a new conversation topic if none of the available conversation topics match the natural language request.

The conversation engine 160 generates a new prompt P2 for the machine learning based language model 150 requesting the machine learning based language model 150 to generate a response to the natural language request. The prompt P2 includes the description of the conversation topic that was identified as relevant to the natural language request. If there are any actions to be performed in connection to the conversation topic, the conversation engine 160 includes the corresponding information in the prompt so that the machine learning based language model 150, ay include language related to the action for the user. The conversation engine 160 retrieves 760 the response generated by the machine learning based language model 150 based on the prompt P2. The conversation engine 160 presents 770 a response to the natural language request based on the response generated by the machine learning based language model 150. The conversation engine 160 further updates the information describing the conversation topic that was identified to include the recent interaction with the user.

According to an embodiment, the system allows a user to switch conversation topics during a session. For example, a user may consecutively ask a set of natural language questions related to a particular topic. The user may next ask a natural language question related to a different topic. The system determines that the user switched the topic based on the above processes. The system determines the new conversation topic and uses the new conversation topic to generate responses to the users natural language question. The user may subsequently switch back to the first conversation topic. The system determines that the user switched back to the first conversation topic and starts using the first conversation topic for determining answers to subsequent questions.

Even though the embodiments described herein use multiple prompts for generating a reply to a natural language question using a conversation topic, the system may generate the reply using a single prompt. For example, the system may either generate a conversation topic for a natural language request using on a first prompt and provide the conversation topic as input to the next prompt to determine a response to the natural language request. Alternatively, the system may use a single prompt that requests the machine learning based model to determine a conversation topic for the natural language request and use it for generating a response for the natural language request.

Accordingly, the system generates a response based on one or more prompts provided to the machine learning based language model that result in one or more responses. The system may use the information I1 received in one response R1 for providing to the next prompt that generates response R2. Alternatively, the system may request the machine learning based model using a single prompt to determine information I1 and use it for generating the response R2.

### Conversation Critic

The conversation engine 160 includes a conversation critic module 230 that analyzes an ongoing online conversation between two or more entities to perform critical analysis of the conversation. The entities participating in the conversation may include a user and a system that automatically generates responses to natural language requests from the user, for example, the conversation engine 160 itself. The conversation critic module 230 analyzes the conversation to monitor various attributes of the conversation, for example, pacing, type of personality of each entity participating in the conversation during the conversation. The critical analysis is used by the conversation engine to modify subsequent interactions with the user. For example, if the conversation critic module 230 determines that the pace of the conversation is slow (i.e., below a threshold value), the conversation engine 160 may modify the conversation to increase the pace of the conversation. For example, if the conversation engine 160 is spending a lot of interactions for each conversation flow or conversation topic, the conversation engine 160 may increase the pace of the conversation by asking fewer questions and covering more conversation topics with fewer interactions. The conversation engine 160 may adjust certain parameters of the conversation flow or conversation topics based on the critical analysis. The conversation engine 160 may adjust the prompts sent to the machine learning based language model 150 to generate responses based on the critical analysis. The conversation engine 160 may include the critical analysis to the machine learning based language model 150 in a prompt and instruct the machine learning based language model 150 to generate a response that will help improve certain attributes of the conversation. Other attributes of the conversation that are monitored by the conversation critic module 230 include a personality of each entity participating in the conversation. For example, the conversation critic module 230 may analyze the conversation to indicate that the conversation engine 160 is being very aggressive during the conversation. Accordingly, the conversation engine 160 may adjust the responses to be less aggressive. The conversation critic module 230 may determine a type of personality of a user in the conversation. The conversation engine 160 may adjust the responses to match the personality of the user. The conversation critic module 230 may also analyze the conversation to determine how well the conversation engine 160 is matching the personality of the user. If the conversation critic module 230 determines that the conversation engine 160 is not matching the personality of the user, the conversation engine 160 may generate prompts for the machine learning based language model 150 providing information about the user's personality and requesting the machine learning based language model 150 to generate responses that match the personality of the user.

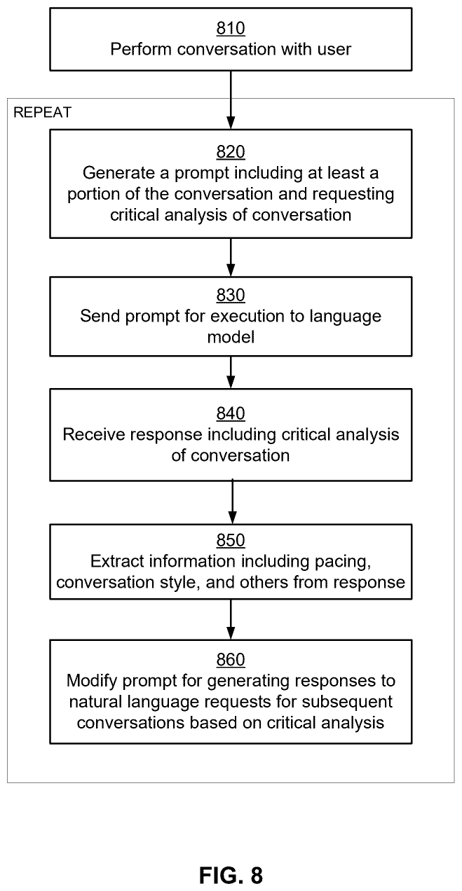

FIG. 8 is a flowchart for performing an online conversation with a user of an organization, in accordance with one or more embodiments. Alternative embodiments may include more, fewer, or different steps from those illustrated in FIG. 3, and the steps may be performed in a different order from that illustrated in FIG. 3. These steps may be performed by a system (e.g., online system 140). Additionally, each of these steps may be performed automatically by the online system without human intervention. The steps may be performed by the modules of the online system, for example, the conversation critic module 230 of the conversation engine 160. Another attribute calculated by the conversation critic module 230 indicates whether it is appropriate time to present a survey to the user to get user feedback. This is significant since under some situations, a user may not want to respond to a survey. Presenting the survey at the appropriate time maximizes the likelihood that the user would answer the survey.

Following is an example response generated by the machine learning based language model 150 that provides critical analysis of a conversation.

```
{
  “personalization”:{
    “user_personality”:“The user appears to be open-minded and receptive to guidance,
with a neutral and straightforward tone.”,
      “coach_personality”:“A warm and approachable coach personality with an empathic,
but direct tone would work best for the user. The coach should be uplifting and
empowering, while also abiding by the highest ethical standards.”,
      “task”:{
        “name”:“personalization”,
        “outputFields”:[
          “user_personality”,
          “coach_personality”
        ],
        ...
      }
  },
  “survey”:{
      “pacing_grade”:“just right”,
      “task”:{
        “name”:“survey”,
        “outputFields”:[
          “pacing”,
          “pacing_grade”,
          “survey_timing”,
          “ask_now”
        ],
...
      },
      “pacing”:“The coach is maintaining a good rhythm, providing ample space for the
user to share and reflect without rushing through the process.”,
      “survey_timing”:“Given the user's brief responses, it may not be the best time to
solicit feedback as it could disrupt the flow and the user has not yet had a substantial
experience with the coaching.”,
      “ask_now”:“no”
  }
}
```

The conversation engine 160 performs 810 a conversation with a user. Accordingly, the conversation engine 160 receives natural language requests from the user via a user interface and generates responses to the natural language requests using the machine learning based language model 150. The conversation engine 160 repeats the steps 820, 830, 840, 850, 860 multiple times. The conversation engine 160 extracts at least a portion of the conversation comprising a subset of the interactions from the conversation. The conversation engine 160 generates 820 a prompt for the machine learning based language model 150 that includes the portion of the conversation and requests the machine learning based language model 150 perform a critical analysis of the conversation. The prompt may specify the attributes of the conversation that need to be analyzed, for example, pacing, personalities of the participants, and so on. The conversation engine 160 sends 830 the prompt to the language model serving system 120 for executing the machine learning based language model 150 using the prompt. The conversation engine 160 receives a response generated by the machine learning based language model 150 based on the prompt. The response includes a critical analysis of the conversation as determined by the machine learning based language model 150. The conversation engine 160 extracts 850 individual attributes describing the critical analysis, for example, a measure of the pacing of the conversation, a conversation style, a type of personality of each participant in the conversation and so on. The conversation engine 160 modifies prompts generates for the machine learning based language model 150 for generating responses to subsequent natural language requests received from the user based on the critical analysis. For example, the conversation engine 160 may modify the prompt to improve certain aspects of the conversation based on the critical analysis.

### APPLICATIONS

The online conversations may be used for advising users associated with an organization. For example, an expert user may play a specific role in an organization, for example, a manager or a human resources personnel. The expert user may receive queries from users for example, employees of the organization. The expert user may use the online system to determine how to respond to the questions of the user. Accordingly, the expert user may provide the questions of the user to the online system and may receive guidance on how to conduct a conversation with the user to address the user's concern. The online system may act as a coach for users including expert users such as managers and human resource personnel who are advising employees of an organization or as a coach for the employees who prefer to use the online system on their own.

The system guides conversations appropriately using techniques such as conversation flow routing. This provides a better user experience for the end user of the online system. For example, the guided conversations performed by the online system result in fewer user interactions. Furthermore, the online system uses a conversation critic that performs critical analysis of the conversation thereby adjusting the conversation, for example, by changing the pace of the conversation or the personality used by the online system for performing the conversation. This further improves the user experience.

The use of vector databases for obtaining information relevant to a particular user performs semantic match for obtaining relevant information. This is more effective compared to systems or users that use text search for obtaining relevant information since several types if information may not have the appropriate keywords matching the search keywords. As a result, there are fewer searches performed across the data stored in the system, thereby improving the computational efficiency of the process as well as by improving the quality of result and thereby improving the user experience.

The system also incorporates information from data stored by the organization, for example, communications performed by the user via various communication channels such as emails and messaging channels. This information may not be exposed to an expert user that using the online system as a coach while still improving the quality of searches performed and the providing answers that incorporate the result underneath. As a result, the privacy of data of the end user is preserved by not exposing confidential information even to the expert user. Accordingly, the system improves the quality of answers provided to the end user while preserving privacy of information of the user. An expert user performing text searches manually to provide similar answers would be exposed to the confidential information of the end user thereby compromising the data privacy of the end user. For example, a manager may not be authorized to access communications of the end user via emails and messages. However, the online system uses the information internally, while improving the quality of responses without exposing the confidential information oft the end user to the expert user advising the end user.

Therefore, the processes described herein provide technical improvements to existing techniques through various mechanisms thereby (1) improving the user experience (2) improving the computational efficiency of the processes and (3) by maintaining data privacy while managing to user the confidential information to provide higher quality of replies for questions of end users.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A computer-implemented method for managing conversation topics in an online conversation, comprising:
performing a conversation comprising one or more interactions with a user via a user interface, each interaction comprising a natural language request received from the user and a reply to the natural language request generated using a machine learning based language model;
generating metadata describing a set of conversation topics based on the conversation, wherein the metadata describes a particular conversation topic comprises a summary of interactions relevant to the particular conversation topic; and
repeatedly performing:
receiving a natural language request from the user via the user interface;
generating one or more prompts for providing to a machine learning based language model, the one or more prompts comprising the natural language request and metadata describing the set of conversation topics, the one or more prompts requesting the machine learning based language model to generate a reply to the natural language request in relation to a conversation topic relevant to the natural language request;
providing the one or more prompts to the machine learning based language model for execution;
receiving a response generated by the machine learning based language model based on the one or more prompts; and
sending a reply based on the response for display via the user interface.

2. The computer-implemented method of claim 1, wherein the one or more prompts comprise:
a first prompt comprising the natural language request and metadata describing the set of conversation topics and requesting the machine learning based language model to identify the conversation topic relevant to the natural language request; and
a second prompt comprising the natural language request and a particular conversation topic, the second prompt requesting the machine learning based language model to generate a reply to the natural language request in relation to the conversation topic.

3. The computer-implemented method of claim 2, wherein providing the one or more prompts to the machine learning based language model for execution comprises:
providing the first prompt to the machine learning based language model for execution;
receiving a response generated by the machine learning based language model based on the first prompt, the response identifying the particular conversation topic relevant to the natural language request; and
providing the second prompt to the machine learning based language model for execution.

4. The computer-implemented method of claim 1, further comprising:
configuring, by an online system, a user interface for performing conversations associated with an organization, wherein each conversation is performed by the online system with a user of the organization, wherein the user interface displays information describing the set of conversation topics.

5. The computer-implemented method of claim 1, wherein the metadata describing a conversation topic further comprises: possible outcomes related to the conversation topic, options related to the conversation topic, or actions related to the conversation topic.

6. The computer-implemented method of claim 1, wherein the conversation comprises:
a first set of natural language questions associated with a first conversation topic;
a second set of natural language questions received from the user after the first set of natural language questions, the second set of natural language questions associated with a second conversation topic; and
a third set of natural language questions received from the user after the second set of natural language questions, the third set of natural language questions associated with the first conversation topic.

7. The computer-implemented method of claim 6, wherein replies generated in response to each of the first set of natural language questions are based on the first conversation topic, wherein replies generated in response to each of the second set of natural language questions are based on the second conversation topic, and wherein replies generated in response to each of the third set of natural language questions are based on the first conversation topic.

8. A non-transitory computer readable storage medium storing instructions that when executed by one or more computer processors cause the one or more computer processors to perform steps for managing conversation topics in an online conversation, comprising:
performing a conversation comprising one or more interactions with a user via a user interface, each interaction comprising a natural language request received from the user and a reply to the natural language request generated using a machine learning based language model;
generating metadata describing a set of conversation topics based on the conversation, wherein the metadata describes a particular conversation topic comprises a summary of interactions relevant to the particular conversation topic; and
repeatedly performing:
receiving a natural language request from the user via the user interface;
generating one or more prompts for providing to a machine learning based language model, the one or more prompts comprising the natural language request and metadata describing the set of conversation topics, the one or more prompts requesting the machine learning based language model to generate a reply to the natural language request in relation to a conversation topic relevant to the natural language request;
providing the one or more prompts to the machine learning based language model for execution;
receiving a response generated by the machine learning based language model based on the one or more prompts; and
sending a reply based on the response for display via the user interface.

9. The non-transitory computer readable storage medium of claim 8, wherein the one or more prompts comprise:
a first prompt comprising the natural language request and metadata describing the set of conversation topics and requesting the machine learning based language model to identify the conversation topic relevant to the natural language request; and
a second prompt comprising the natural language request and a particular conversation topic, the second prompt requesting the machine learning based language model to generate a reply to the natural language request in relation to the conversation topic.

10. The non-transitory computer readable storage medium of claim 9, wherein providing the one or more prompts to the machine learning based language model for execution comprises:
providing the first prompt to the machine learning based language model for execution;
receiving a response generated by the machine learning based language model based on the first prompt, the response identifying the particular conversation topic relevant to the natural language request; and
providing the second prompt to the machine learning based language model for execution.

11. The non-transitory computer readable storage medium of claim 8, wherein the instructions cause the one or more computer processors to performs steps comprising:
configuring, by an online system, a user interface for performing conversations associated with an organization, wherein each conversation is performed by the online system with a user of the organization, wherein the user interface displays information describing the set of conversation topics.

12. The non-transitory computer readable storage medium of claim 8, wherein the metadata describing a conversation topic further comprises: possible outcomes related to the conversation topic, options related to the conversation topic, or actions related to the conversation topic.

13. The non-transitory computer readable storage medium of claim 8, wherein the conversation comprises:
a first set of natural language questions associated with a first conversation topic;
a second set of natural language questions received from the user after the first set of natural language questions, the second set of natural language questions associated with a second conversation topic; and
a third set of natural language questions received from the user after the second set of natural language questions, the third set of natural language questions associated with the first conversation topic.

14. The non-transitory computer readable storage medium of claim 13, wherein replies generated in response to each of the first set of natural language questions are based on the first conversation topic, wherein replies generated in response to each of the second set of natural language questions are based on the second conversation topic, and wherein replies generated in response to each of the third set of natural language questions are based on the first conversation topic.

15. A computer system comprising:
one or more computer processors; and
a non-transitory computer readable storage medium storing instructions that when executed by one or more computer processors cause the one or more computer processors to perform steps for managing conversation topics in an online conversation, comprising:
performing a conversation comprising one or more interactions with a user via a user interface, each interaction comprising a natural language request received from the user and a reply to the natural language request generated using a machine learning based language model;
generating metadata describing a set of conversation topics based on the conversation, wherein the metadata describes a particular conversation topic comprises a summary of interactions relevant to the particular conversation topic; and
repeatedly performing:
receiving a natural language request from the user via the user interface;
generating one or more prompts for providing to a machine learning based language model, the one or more prompts comprising the natural language request and metadata describing the set of conversation topics, the one or more prompts requesting the machine learning based language model to generate a reply to the natural language request in relation to a conversation topic relevant to the natural language request;
providing the one or more prompts to the machine learning based language model for execution;
receiving a response generated by the machine learning based language model based on the one or more prompts; and
sending a reply based on the response for display via the user interface.

16. The computer system of claim 15, wherein the one or more prompts comprise:
a first prompt comprising the natural language request and metadata describing the set of conversation topics and requesting the machine learning based language model to identify the conversation topic relevant to the natural language request; and
a second prompt comprising the natural language request and a particular conversation topic, the second prompt requesting the machine learning based language model to generate a reply to the natural language request in relation to the conversation topic.

17. The computer system of claim 16, wherein providing the one or more prompts to the machine learning based language model for execution comprises:
providing the first prompt to the machine learning based language model for execution;
receiving a response generated by the machine learning based language model based on the first prompt, the response identifying the particular conversation topic relevant to the natural language request; and
providing the second prompt to the machine learning based language model for execution.

18. The computer system of claim 15, wherein the metadata describing a conversation topic further comprises: possible outcomes related to the conversation topic, options related to the conversation topic, or actions related to the conversation topic.

19. The computer system of claim 15, wherein the conversation comprises:
a first set of natural language questions associated with a first conversation topic;
a second set of natural language questions received from the user after the first set of natural language questions, the second set of natural language questions associated with a second conversation topic; and
a third set of natural language questions received from the user after the second set of natural language questions, the third set of natural language questions associated with the first conversation topic.

20. The computer system of claim 19, wherein replies generated in response to each of the first set of natural language questions are based on the first conversation topic, wherein replies generated in response to each of the second set of natural language questions are based on the second conversation topic, and wherein replies generated in response to each of the third set of natural language questions are based on the first conversation topic.
